(19) United States
(12) Patent Application Publication
(10) Pub. No.: US 2008/0119627 A1
(43) Pub. Date: May 22, 2008

(54) METHODS FOR PURIFYING SILOXANYL MONOMERS

(76) Inventors: Masataka Nakamura, Otsu (JP); Takehiro Kohara, Otsu (JP); Hiroya Koyama, Izumo (JP); Shinya Kiguchi, Kakogawa (JP)

Correspondence Address: NEEDLE & ROSENBERG, P.C., SUITE 1000, 999 PEACHTREE STREET, ATLANTA, GA, 30309-3915, US

(21) Appl. No.: 11/681,406

(22) Filed: Mar. 2, 2007

Related U.S. Application Data
(60) Provisional application No. 60/866,888, filed on Nov. 22, 2006.

(51) Int. Cl. B01D 3/00; C08G 77/12

(52) U.S. Cl. 528/31; 203/8; 528/33; 556/451

(57) ABSTRACT

Disclosed are reduced pressure distillation methods for purifying siloxanyl monomers in the presence of at least one polymerization inhibitor. In further aspects, the polymerization inhibitor can be an alkylhydroquinone or a hydroxynaphthalene. Also disclosed are compounds purified by the disclosed methods and polymers produced therefrom. This abstract is intended as a scanning tool for purposes of searching in the particular art and is not intended to be limiting of the present invention.

### CROSS REFERENCE TO RELATED APPLICATIONS

This application claims the benefit of U.S. Application No. 60/866,888 filed Nov. 22, 2006, which is hereby incorporated herein by reference in its entirety.

### BACKGROUND

In conventional distillation of a siloxanyl monomer, if the monomer is subjected to too high of a temperature, it can be contaminated with polymerization product(s) that can occur during heating; the yield is, therefore, decreased. On the other hand, if a low temperature is employed during the purification step, it can be difficult to purify, for example, a siloxanyl monomer having a relatively high molecular weight by distillation. To compound this difficulty, a siloxanyl monomer subjected to distillation under reduced pressure can become discolored during the purification, so that the quality of the product is degraded.

Therefore, there remains a need for purification methods that overcome these deficiencies and that effectively provide for the purification of siloxanyl monomers without substantial amounts of polymerization product(s) and without discoloration.

### SUMMARY

As embodied and broadly described herein, the invention, in one aspect, relates to reduced pressure distillation methods for purifying siloxanyl monomers in the presence of at least one polymerization inhibitor. In further aspects, the polymerization inhibitor can be an alkylhydroquinone or a hydroxynaphthalene.

In a further aspect, the invention relates to compounds purified by the disclosed methods and polymers produced therefrom.

In a further aspect, the invention relates to molded articles, ophthalmic lenses, and contact lenses comprising the disclosed polymers.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular embodiments only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which may need to be independently confirmed.

### A. Definitions

As used in the specification and the appended claims, the singular forms “a,” “an” and “the” include plural referents unless the context clearly dictates otherwise. Thus, for example, reference to “a component,” “a polymer,” or “a residue” includes mixtures of two or more such components, polymers, or residues, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

A “residue” of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

As used herein, the terms “optional” or “optionally” means that the subsequently described event or circumstance may or may not occur, and that the description includes instances where said event or circumstance occurs and instances where it does not.

As used herein, the term “polymer” refers to a relatively high molecular weight organic compound, natural or synthetic (e.g., polyethylene, rubber, cellulose), whose structure can be represented by a repeated small unit, the monomer (e.g., ethane, isoprene, β-glucose). Synthetic polymers are typically formed by addition or condensation polymerization of monomers.

It is understood that a polymer (e.g., poly(methyl acrylate)) can have a structure represented by one or more monomers and represented by a formula:

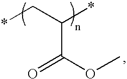

wherein n represents the number of monomer units in a particular polymer molecule or the average number of monomer units in a collection of polymer molecules. It is understood that, in certain aspects, a polymer can be provided as a collection of polymer molecules having a distribution of n, with an average value for n, which may be represented as a range of values or as an approximate value, e.g., n is from about 10 to about 30 or n is about 15. It is also understood that the polymer can further comprise end groups, for example initiation and termination groups. While the formula written for a polymer can optionally omit the end groups (e.g., initiation and termination groups), these groups can still be present in the polymer molecule.

As used herein, the term “oligomer” refers to a relatively low molecular weight polymer in which the number of repeating units is between two and ten, for example, from two to eight, from two to six, or form two to four. In one aspect, a collection of oligomers can have an average number of repeating units of from about two to about ten, for example, from about two to about eight, from about two to about six, or form about two to about four.

As used herein, the term “copolymer” refers to a polymer formed from two or more different repeating units (monomer residues). By way of example and without limitation, a copolymer can be an alternating copolymer, a random copolymer, a block copolymer, or a graft copolymer.

As used herein, the term “reduced pressure distillation” refers to the act of purifying liquids through evaporating or boiling at a pressure lower than about atmospheric pressure (i.e., about 1000 mbar or about 760 Torr), so that the gaseous vapors condense to a pure liquid. Pollutants and contaminants typically remain in a concentrated residue. The pressure can be, for example, less than about 100 mbar, less than about 10 mbar, less than about 1 mbar, less than about 0.1 mbar, less than about 0.05 mbar, or less than about 0.02 mbar. An apparatus for distilling typically includes a distilling vessel (which holds the pre-distillation material during heating), a condenser (which cools the evaporated material), and a receiving vessel (which collects the distillate). In one aspect, distillation does not include chemical vapor deposition.

As used herein, the term “thin film distillation” refers to short path distillation wherein a substantial decrease of boiling temperature is obtained by reducing the operating pressure. This can allow thermal separation of products that would be destroyed by conventional vacuum distillation (pot still or distillation column) because of the necessary high temperatures and long residence time. Such as method can also be referred to as “thin-layer distillation” and can, in various aspects, include film distillation, falling-film distillation, and molecular distillation (short-path or open-path distillation). In thin-layer evaporation, the liquid to be evaporated is typically mechanically distributed, e.g., by gravitation, centrifugal force, or mechanical wipers, thereby forming thin layers which are typically less than 0.5 mm, for example less than 0.3 mm or less than 0.2 mm or less than 0.1 mm, thick and which can be evaporated at reduced pressure.

As used herein, the term “polymerization inhibitor,” sometimes also referred to as a “radical inhibitor” or a “radical scavenger,” refers to a substance that impedes or retards the process of polymerization. Typically, such an inhibitor slows or prevents the formation of radicals, which can initiate polymerization. Alternatively, such an inhibitor can react with any formed radicals at a rate greater than the polymerization initiation and/or propagation steps. Examples of suitable polymerization inhibitors include alkylhydroquinones and hydroxynaphthalenes.

In one aspect, a polymerization inhibitor can be present during the distillation of the disclosed materials. In a further aspect, a polymerization inhibitor can be present in the distilling vessel of the distillation. In a yet further aspect, a polymerization inhibitor can be selected so as to undergo volatization during the distillation process; that is, at least a portion of the polymerization inhibitor would be present with the distilled product. In an even further aspect, a polymerization inhibitor can be selected so as to not volatize during the distillation process; that is, the polymerization inhibitor would remain with any undistilled materials and would be substantially absent from the distilled product. In a still further aspect, a second polymerization inhibitor, which can be the same or different from the first polymerization inhibitor, can be present in the receiving vessel of the distillation.

As used herein, the term “siloxanyl” refers to a structure having at least one Si—O—Si bond. Thus, for example, siloxanyl group means a group having at least one Si—O—Si moiety, and siloxanyl compound means a compound having at least one Si—O—Si group.

As used herein, the term “siloxanyl monomer” refers to a siloxanyl compound having at least one polymerizable carbon-carbon unsaturated bond. In one aspect, the polymerizable carbon-carbon unsaturated bond can be part of an alkylacryloyl moiety (e.g., acryloyl or a methacryloyl moiety).

As used herein, the term “alkylacrylic acid” refers to acrylic acid, alkyl-substituted acrylic acids, salts thereof, and derivatives thereof. In one aspect, an alkylacrylic acid can be further substituted. In a further aspect, an alkylacrylic acid is acrylic acid or methacrylic acid or esters thereof.

As used herein, the term “hydrolyzable group” refers to a group or moiety which is convertible to hydrogen by hydrolysis or solvolysis. In one aspect, a hydrolyzable group can be hydrolyzed (i.e., converted to a hydrogen group) by exposure to water or a protic solvent at or near ambient temperature and at or near atmospheric pressure. In further aspects, a hydrolyzable group can be hydrolyzed by exposure to water or a protic solvent at an elevated temperature or an elevated pressure. In further aspects, a hydrolyzable group can be hydrolyzed by exposure to acidic or alkaline water or acidic or alkaline protic solvent.

As used herein, the term “alkylhydroquinone” refers to an alkyl-substituted 1,4-dihydroxybenzene, which can be represented by the structure below:

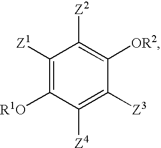

wherein R¹ and R² are independently hydrogen, alkyl, aryl, or a hydrolyzable group, wherein at least one of R¹ and R² comprises a hydrogen, and wherein Z¹, Z², Z³, and Z⁴ can independently comprise a hydrogen, an alkyl group or other substituent, wherein at least one of Z¹, Z², Z³, and Z⁴ comprises an alkyl group.

As used herein, the term “hydroxynaphthalene,” sometimes also referred to as a “napthol,” refers to naphthalene substituted with at least one hydroxyl group, which can be represented by the structure below:

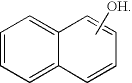

In one aspect, the hydroxynaphthalene can be, for example, a 1-naphtol or a 2-napthol. In a further aspect, the hydroxynaphthalene can be an alkoxy naphthol, a dihydroxynaphthol, or a dialkoxynaphthol. That is, the naphthol can have more than one hydroxyl group and one or more of the hydroxyl groups can be substituted with, for example, an alkyl group or other substituent. Also, the disclosed hydroxynaphthalenes can be further substituted with, for example, an alkyl group or other substituent.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. Unless explicitly disclosed, this disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

In defining various terms, “A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “alkyl” as used herein is a branched or unbranched saturated hydrocarbon group of 1 to 24 carbon atoms, for example 1 to 12 carbon atoms or 1 to 6 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein. A “lower alkyl” group is an alkyl group containing from one to six carbon atoms.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The term “heterocycloalkyl” is a type of cycloalkyl group as defined above, and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The terms “alkoxy” and “alkoxyl” as used herein to refer to an alkyl or cycloalkyl group bonded through an ether linkage; that is, an “alkoxy” group can be defined as —OA¹ where A¹ is alkyl or cycloalkyl as defined above. “Alkoxy” also includes polymers of alkoxy groups as just described; that is, an alkoxy can be a polyether such as —OA¹-OA² or —OA¹-(OA²)ₐ—OA³, where “a” is an integer of from 1 to 200 and A¹, A², and A³ are alkyl and/or cycloalkyl groups.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkenyl” as used herein is a non-aromatic carbon-based ring composed of at least three carbon atoms and containing at least one carbon-carbon double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, norbornenyl, and the like. The term “heterocycloalkenyl” is a type of cycloalkenyl group as defined above, and is included within the meaning of the term “cycloalkenyl,” where at least one of the carbon atoms of the ring is replaced with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “alkynyl” as used herein is a hydrocarbon group of 2 to 24 carbon atoms with a structural formula containing at least one carbon-carbon triple bond. The alkynyl group can be unsubstituted or substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkynyl” as used herein is a non-aromatic carbon-based ring composed of at least seven carbon atoms and containing at least one carbon-carbon triple bound. Examples of cycloalkynyl groups include, but are not limited to, cycloheptynyl, cyclooctynyl, cyclononynyl, and the like. The term “heterocycloalkynyl” is a type of cycloalkenyl group as defined above, and is included within the meaning of the term “cycloalkynyl,” where at least one of the carbon atoms of the ring is replaced with a heteroatom such as, but not limited to, nitrogen, oxygen, sulfur, or phosphorus. The cycloalkynyl group and heterocycloalkynyl group can be substituted or unsubstituted. The cycloalkynyl group and heterocycloalkynyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “aryl” as used herein is a group that contains any carbon-based aromatic group including, but not limited to, benzene, naphthalene, phenyl, biphenyl, phenoxybenzene, and the like. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term “non-heteroaryl,” which is also included in the term “aryl,” defines a group that contains an aromatic group that does not contain a heteroatom. The aryl group can be substituted or unsubstituted. The aryl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein. The term “biaryl” is a specific type of aryl group and is included in the definition of “aryl.” Biaryl refers to two aryl groups that are bound together via a fused ring structure, as in naphthalene, or are attached via one or more carbon-carbon bonds, as in biphenyl.

Unless stated to the contrary, a formula with chemical bonds shown only as solid lines and not as wedges or dashed lines contemplates each possible isomer, e.g., each enantiomer and diastereomer, and a mixture of isomers, such as a racemic or scalemic mixture.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. Reduced Pressure Distillation of Siloxanyl Monomers

In one aspect, the disclosed methods provide an advantage over conventional techniques in that even if a siloxanyl monomer is subjected to conventional distillation methods under reduced pressure at a high temperature, contamination of the product with polymerization products does not occur or occurs at substantially reduced levels, and a high yield can be attained. Further, a relatively high temperature can be necessary during the purification step, so that, for example, a siloxanyl monomer having a relatively high molecular weight can be purified by distillation. The disclosed methods achieve this advantage by distillation in the presence of a polymerization inhibitor. In one aspect, the polymerization inhibitor can comprise one or more of an alkylhydroquinone or a hydroxynaphthalene. In certain aspects wherein a hydroxynaphthalene compound is used as a polymerization inhibitor, coloring in yellow or brown does not substantially occur, and a product with a high quality can be obtained.

In one aspect, the invention relates to a method for purifying a siloxanyl monomer, the method comprising the step of reduced pressure distillation of the siloxanyl monomer in the presence of at least one polymerization inhibitor comprising an alkylhydroquinone or a hydroxynaphthalene. In a further aspect, the method further comprises the step of collecting the distilled siloxanyl monomer. The monomer can be collected, for example, in a receiving vessel.

Typically, the compounds having the highest polymerization inhibitory effect are hydroxynaphthalenes, and the compounds having the second highest polymerization inhibitory effect are hydroquinone compounds having an alkyl group(s). Typically, the order of the polymerization inhibitory effect of the specific compounds is as follows: 4-methoxynaphthol>2-t-butylhydroquinone>2,5-di-t-butylhydroquinone.

In general, the polymerization inhibitor is added to and dissolved in the reaction solution before the solution is fed to the reduced pressure distillation (e.g., thin film distillation) device. As long as the admixing of the polymerization inhibitor into the product does not give rise to a quality problem, the polymerization inhibitor as a solution in the product or a suitable solvent can be introduced midway the vapor line or to the stream after condensation in the condenser.

1. Hydroxynaphthalens

In one aspect, the at least one polymerization inhibitor comprises a hydroxynaphthalene. The hydroxynaphthalene can be, for example, an alkoxy naphthol, a dihydroxynaphthol, or a dialkoxynaphthol. In one aspect, the hydroxynaphthalene is 4-methoxy-1-naphthol.

In one aspect, the hydroxynaphthalene can be 1-naphthol or α-naphthol:

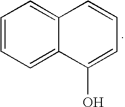

It is contemplated that the 1-naphthol can be optionally further substituted with, for example, one or more alkyl or alkoxy groups.

It is also contemplated that the 1-naphthol can be provided as an optionally substituted dihydroxynaphalene:

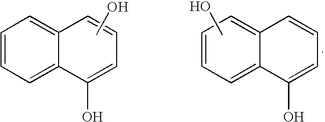

The dihydroxynaphalene can be, for example, 1,2-dihydroxynaphthalene, 1,3-dihydroxynaphthalene, 1,4-dihydroxynaphthalene, 1,5-dihydroxynaphthalene, 1,6-dihydroxynaphthalene, 1,7-dihydroxynaphthalene, or 1,8-dihydroxynaphthalene. It is also contemplated that the naphthol can be provided as a trihydroxynaphthalene and/or a tetrahydroxynaphthalene. It is further contemplated that the naphthol can be provided as a mixture of naphthols, optionally including mono-, di-, tri-, and/or tetra-hydroxynaphthalenes.

In one aspect, the hydroxynaphthalene can be 2-naphthol or β-naphthol:

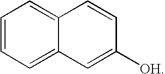

It is contemplated that the 2-naphthol can be optionally further substituted with, for example, one or more alkyl or alkoxy groups.

It is also contemplated that the 2-naphthol can be provided as an optionally substituted dihydroxynaphalene:

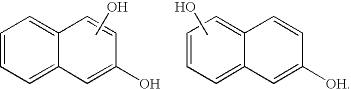

The dihydroxynaphalene can be, for example, 1,2-dihydroxynaphthalene, 2,3-dihydroxynaphthalene, 2,4-dihydroxynaphthalene, 2,5-dihydroxynaphthalene, 2,6-dihydroxynaphthalene, 2,7-dihydroxynaphthalene, or 2,8-dihydroxynaphthalene. It is also contemplated that the naphthol can be provided as a trihydroxynaphthalene and/or a tetrahydroxynaphthalene. It is further contemplated that the naphthol can be provided as a mixture of naphthols, optionally including mono-, di-, tri-, and/or tetra-hydroxynaphthalenes.

In one aspect, certain hydroxynaphthalenes can be degraded by the action of light (i.e., photodegradable). Photodegradable hydroxynaphthalene inhibitors include 4-methoxy-1-naphthol, 4-naphthalenediol, and 1,5-naphthalenediol. It is understood that, if photodegradation is not desired, the use of such hydroxynaphthalene inhibitors can be performed while minimizing or eliminating exposure to light. On the other hand, if photodegradation is desired, exposure to light can be used to remove hydroxynaphthalene inhibitors from a reaction, for example, upon completion of distillation.

2. Alkylhydroquinones

In a further aspect, the at least one polymerization inhibitor comprises an alkylhydroquinone. The alkylhydroquinone can be, for example, 2-t-butylhydroquinone or 2,6-di-t-butylhydroquinone. In one aspect, the alkylhydroquinone is 2-t-butylhydroquinone.

The alkyl group can comprise, for example, a substituted or unsubstituted C₁ to C₁₂ alkyl group. In one aspect, the alkyl group is selected from methyl, ethyl, propyl, butyl, pentyl, hexyl, heptyl, octyl, nonyl, decyl, undecyl, and dodecyl. In a further aspect, the alkyl group is a tertiary alkyl group.

In one aspect, the alkylhydroquinone can be represented by the structure below:

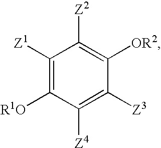

wherein R¹ and R² are independently hydrogen, alkyl, aryl, or a hydrolyzable group, wherein at least one of R¹ and R² comprises a hydrogen, and wherein Z¹, Z², Z³, and Z⁴ can independently comprise a hydrogen, an alkyl group or other substituent, wherein at least one of Z¹, Z², Z³, and Z⁴ comprises an alkyl group.

In a further aspect, the alkylhydroquinone can be represented by the structure below:

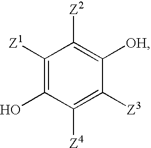

wherein Z¹, Z², Z³, and Z⁴ can independently comprise a hydrogen, an alkyl group or other substituent, wherein at least one of Z¹, Z², Z³, and Z⁴ comprises an alkyl group. For example, Z², Z³, and Z⁴ can be hydrogen and Z¹ can be alkyl. In a further example, Z² and Z³ can be hydrogen, and Z¹ and Z⁴ can be alkyl groups, which can be the same or different. In a yer further example, Z² and Z⁴ can be hydrogen, and Z¹ and Z³ can be alkyl groups, which can be the same or different. In a still further example, Z³ and Z⁴ can be hydrogen, and Z¹ and Z² can be alkyl groups, which can be the same or different. In further examples, three or four of Z¹, Z², Z³, and Z⁴ are alkyl groups, which can be the same or different.

It is also contemplated that the disclosed alkylhydroquinones can be optionally further substituted.

3. Siloxanyl Monomers

In one aspect, the disclosed methods can be used to purify a siloxanyl monomer is represented by the following Formula (A1-1) or (A1-2):

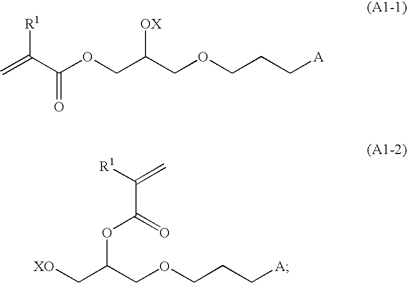

wherein R¹ represents hydrogen, substituted or unsubstituted C₁-C₁₈ alkyl, or substituted or unsubstituted phenyl; wherein X represents hydrogen or a hydrolyzable group; and A represents a siloxanyl group.

In a further aspect, A is a group represented by the following Formula (B1):

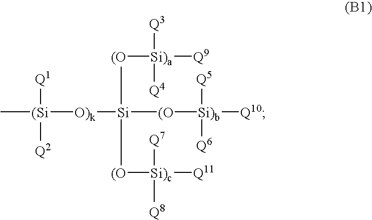

wherein Q¹ to Q¹¹ independently represent hydrogen, substituted or unsubstituted C₁-C₂₀ alkyl, or substituted or unsubstituted C₆-C₂₀ aryl; wherein k represents an integer of 0 to 200; and wherein a, b, and c independently represent integers of 0 to 20, with the proviso that k, a, b, and c are not simultaneously zero.

In a yet further aspect, A is a group represented by the following Formula (B2):

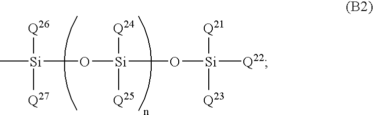

wherein Q²¹ to Q²⁷ independently represent hydrogen, substituted or unsubstituted C₁-C₁₈ alkyl, or substituted or unsubstituted phenyl; and wherein n represents an integer of 0 to 12.

The siloxanyl monomer can be selected to have a molecular weight of from about 500 to about 3000. For example, the molecular weight of from about 500 to about 2000, from about 500 to about 1000, from about 1000 to about 3000, from about 1000 to about 2000, greater than about 500, greater than about 600, greater than about 750, or greater than about 1000.

4. Distillation Conditions

In one aspect, the distillation is short path distillation, for example, thin film distillation.

In a further aspect, the distillation is carried out at a temperature of at least 110° C., for example, of at least 120° C., of at least 130° C, of at least 140° C., or of at least 150° C.

In certain aspects, the disclosed methods can further comprise additional steps, for example, the step of removing at least a portion of the at least one polymerization inhibitor. The polymerization inhibitor can be removed by, for example, washing, filtration, or subsequent chemical reaction. In one aspect, the step of removing at least a portion of the at least one polymerization inhibitor is performed by washing of the reaction mixture with an alkaline aqueous solution. Treatment with at least one absorbent is also suitable because it can be effective to eliminate or reduce the color of the siloxanyl monomer. Suitable absorbents include active carbon, silica, silica gel, alumina, zeolites, ion-exchange resins, and the other natural or synthetic resins. In one aspect, the preferable absorbent is active carbon.

5. Thin Film Distillation

In one aspect, a thin film (or thin-layer) distillation device can be used for reduced pressure distillation. Such can be a device of commonly known specification having an agitation drive section of spreading the reaction solution in thin layer form and a heating and evaporation/condensation section of heating the reaction solution thin layer under vacuum for evaporation and condensation. For any of such devices, distillation operation can be carried out by a procedure commonly taken for the operation of that device. The thin film distillation device can be, for example, a centrifugal evaporator in which the feed solution is centrifugally spread by an internal agitating blade over a heating section to form a thin layer, which may be of the lateral or upright type. The heating section can be either a cylindrical type or a tapered type while its heat transfer area is not critical. Among others, an upright falling-film evaporator comprising a cylindrical heating section and a wiper-like agitating blade wherein the tip of the agitating blade is centrifugally urged against the surface of the heating section for scraping the surface can be used because evaporation to a high concentration is possible.

In one aspect, reduced pressure distillation can be effected by thin film distillation in the above-described thin film distillation device under a vacuum of up to 15 mmHg, for example from about 1 to about 15 mmHg, while keeping the heating section at a temperature of up to about 160° C., for example up to about 150° C., up to about 140° C., up to about 130° C., up to about 120° C., up to about 110° C., or up to about 100° C. The distillation time may be adjusted as appropriate in accordance with the feed amount. Depending on the specifications of a particular thin film distillation device used, the amount of the solution fed can be set between the lower limit at which the thin film formed thereby becomes discontinuous and the upper limit at which the rate of evaporation reaches saturation and increases no more. The feed solution is distilled in the thin film distillation device under the above-specified conditions while the remaining conditions can be adjusted as appropriate.

In a further aspect, a mist separator can be connected to the thin film distillation device for separating off mist from the feed solution, if necessary. Specifically, a column of any desired height packed with a commercially available distillation-promoting packing can be connected in a vapor line from the thin film distillation device to a condenser. Alternatively, the mist separator can be mounted upstream of an upper vapor outlet within an upright evaporator.

Where the feed solution to be distilled contains components having a lower boiling point than the main component (e.g., impurities and solvents) a concentration step can be carried out prior to the isolation and purification of the main component, thereby reducing the concentration of such undesirable components to less than, for example, about 1% by weight. This concentration step can be carried out using the thin film distillation device used for reduced pressure distillation. The concentrating conditions are not critical, although an internal temperature of up to about 160° C. and a vacuum of up to about 50 mmHg can be employed. The thin film distillation device can be preheated, if desired. The preheating temperature of the reaction solution is not critical and is typically below about 120° C., for example below about 100° C.

In one aspect, one or more inert liquids having a higher boiling point than the siloxanyl monomer can be added to the reaction solution before it is fed into the reduced pressure distillation apparatus. This addition can minimize precipitation and deposition of any residues (including, e.g., polymerization inhibitor, catalyst, and/or high-boiling impurities) left after distillation. Such high boiling liquids can be, for example, turbine oil, liquid paraffin, and silicone oil.

6. Use of Monomers

In one aspect, the invention relates to a compound purified by the disclosed methods. It is understood that the purified monomers can be used as starting materials in subsequent reactions to form polymers. That is, in a further aspect, the invention also relates to a polymer comprising at least one residue of the disclosed purified compounds. Further, in one aspect, the invention relates to molded articles, ophthalmic lenses, or contact lenses comprising the disclosed polymers.

It is understood that at least a portion of the at least one polymerization inhibitor can be removed before polymerization of the purified monomer to facilitate a subsequent polymerization reaction.

It is known to use purified acryl monomers in, for example, photographic compositions. See, e.g., GB Patent No. 1,231,222 and U.S. Pat. No. 3,563,742. Such compositions include a film-forming oxygen permeable binder, a polymerizable ethylenically unsaturated monomer, and 0.01 to 5% of a photolyzable naphth-1-ol polymerization inhibitor. Such unsaturated monomer(s) are not typically distilled in the presence of a polymerization inhibitor, but are instead but one component of the composition. Suitable film-forming oxygen permeable binders include gelatin and polyvinyl resins such as polyvinyl acetatebutyral, polyvinyl acetate, polyvinyl pyridine, and polyvinyl alcohol. In contrast, it is contemplated that, in one aspect, a binder can be substantially or entirely absent from the disclosed methods and products.

### C. Preparation of Molded Plastics

Molded plastics can be prepared by polymerizing the disclosed purified siloxyanyl monomers of the present invention alone or with one or more comonomers or materials described herein. For example, molded plastics can be obtained by copolymerizing the disclosed purified monomers with one or more compounds selected from the group consisting of a compound having two or more amino groups in the molecule, a compound having two or more hydroxyl groups, a compound having two or more mercapto groups and a compound having two or more carboxyl groups in the molecule.

For preparing molded plastics, especially ophthalmic lenses, additional materials can also be included in the polymerization mixture. For example, a crosslinker having two or more polymerizable carbon-carbon unsaturated bonds in the molecule can be included to obtain good mechanical properties and good resistance to antiseptic solutions and washing solutions. The percentage of the crosslinker, based on the total monomers to be copolymerized, is preferably not less than about 0.01% by weight, more between about 0.05% and about 15% by weight, still more preferably between about 0.1% and about 5% by weight.

From the viewpoint of simultaneously attaining a satisfactory oxygen permeability and satisfactory hydrophilicity, the percentage of the material for producing molded plastics according to the present invention in the prepared molded plastics is, in cases where other siloxanyl-group containing polymerizable material is not copolymerized, preferably from about 30% by weight to about 100% by weight, more preferably from about 50% by weight to about 99% by weight, still more preferably from about 60% by weight to about 95% by weight. In cases where one or more other siloxanyl group-containing polymerizable materials are copolymerized, the percentage of the total of the material according to the present invention and the other siloxanyl group-containing polymerizable material(s) in the prepared molded plastics is preferably from about 30% by weight to about 100% by weight, more preferably from about 50% by weight to about 99% by weight, still more preferably from about 60% by weight to about 95% by weight.

The molded plastics may contain additional components, including, but not limited to UV absorbers, colorants, coloring agents, wetting agents, slip agents, pharmaceutical and nutraceutical components, compatibilizing components, antimicrobial compounds, release agents, combinations thereof and the like. Any of the foregoing may be incorporated in non-reactive, polymerizable, and/or copolymerized form.

In the (co)polymerization for preparing the molded plastics, it is preferred to add a thermal polymerization initiator or photopolymerization initiator typified by peroxides and azo compounds for easily attaining polymerization. In cases where thermal polymerization is carried out, one having the optimum decomposition characteristics at the satisfactory reaction temperature is selected. In general, azo initiators and peroxide initiators having a 10 hour half-life temperature of from about 40° C. to about 120° C. are preferred. Examples of the photoinitiator include carbonyl compounds, peroxides, azo compounds, sulfur compounds, halogenated compounds and metal salts. These polymerization initiators can be used individually or in combination. The amount of the polymerization initiator(s) can be up to about 1% by weight based on the polymerization mixture.

In (co)polymerizing the material for producing molded plastics according to the present invention, a polymerization solvent can be used. As the solvent, various organic and inorganic solvents can be employed. Examples of the solvents include water; alcoholic solvents such as methyl alcohol, ethyl alcohol, normal propyl alcohol, isopropyl alcohol, normal butyl alcohol, isobutyl alcohol, tert-butyl alcohol, ethylene glycol, diethylene glycol, triethylene glycol, tetraethylene glycol and polyethylene glycol; glycol ether solvents such as methyl cellosolve, ethyl cellosolve, isopropyl cellosolve, butyl cellosolve, propylene glycol monomethyl ether, diethylene glycol monomethyl ether, triethylene glycol monomethyl ether, polyethylene glycol monomethyl ether, ethylene glycol dimethyl ether, diethylene glycol dimethyl ether, triethylene glycol dimethyl ether and polyethylene glycol dimethyl ether; ester solvents such as ethyl acetate, butyl acetate, amyl acetate, ethyl lactate and methyl benzoate; aliphatic hydrocarbon solvents such as normal hexane, normal heptane and normal octane; alicyclic hydrocarbon solvents such as cyclohexane and ethylcyclohexane; ketone solvents such as acetone, methyl ethyl ketone and methyl isobutyl ketone; aromatic hydrocarbon solvents such as benzene, toluene and xylene; and petroleum solvents. These solvents can be used individually or two or more of these solvents can be used in combination.

As the method of polymerization of the material for producing molded plastics according to the present invention, and as the method of molding the plastics, known methods can be employed. For example, a method in which the material is once polymerized and molded into the shape of round bar or plate and the resulting round bar or plate is then processed into the satisfactory shape by cutting or the like, mold polymerization method and spin cast polymerization method can be employed.

As an example, a process for producing an ophthalmic lens by polymerizing the disclosed purified siloxanyl monomers by a mold polymerization method will now be described.

First, a gap having a prescribed shape, between two mold parts is filled with the material composition and photopolymerization or thermal polymerization is carried out to shape the composition into the shape of the gap between the molds. The molds are made of a resin, glass, ceramics, metal, or the like. In case of photopolymerization, an optically transparent material is used, and a resin or glass is usually used. In case of producing an ophthalmic lens, a gap is formed between two mold parts facing each other, and the gap is filled with the material composition. Depending on the shape of the gap and on the properties of the material composition, a gasket may be used in order to give the ophthalmic lens a prescribed thickness and to prevent leakage of the material composition filled in the gap. The molds containing the gap filled with the material composition are then irradiated with an actinic radiation such as ultraviolet light, visible light or a combination thereof, or placed in an oven or bath to heat the material composition, thereby carrying out polymerization. The two polymerization methods may be employed in combination, that is, thermal polymerization may be carried out after photopolymerization, or photopolymerization may be carried out after thermal polymerization. In photopolymerization embodiment, a light containing ultraviolet light, such as the light from a mercury lamp or UV lamp (e.g., FL15BL, TOSHIBA corporation) is radiated for a short time (usually not longer than 1 hour). In cases where thermal polymerization is carried out, it is preferred to employ conditions in which the composition is slowly heated from room temperature to a temperature from about 60° C. to about 200° C. over a period of several hours to several tens hours, in view of the optical uniformity, high quality, and high reproducibility of the ophthalmic lens.

The molded plastics produced from the material of the present invention may preferably have a dynamic contact angle (during forward movement, immersion rate: about 0.1 mm/sec) of not more than about 130°, more preferably not more than about 120°, still more preferably not more than about 100°. The water content thereof is preferably from about 3% to about 50%, more preferably from about 5% to about 50%, still more preferably from about 7% to about 50%. From the viewpoint of the wearer when the ophthalmic lens is used as a contact lens, the higher the oxygen permeability, the better. The oxygen permeability coefficient [×10⁻¹¹(cm²/sec)mLO₂/(mL·hPa)] is preferably not less than about 50, more preferably not less than about 60, still more preferably not less than about 65. The tensile modulus of elasticity is preferably from about 0.01 to about 30 MPa, more preferably from about 0.1 to about 7 MPa. The tensile elongation is preferably not less than about 50%, more preferably not less than about 100%. Since a higher tensile elongation gives higher resistance to breakage, it is preferred that the molded plastics have a high tensile elongation. These properties may be measured using the test methods disclosed in WO03/022321.

The molded plastics are useful as drug carriers used for drug delivery, and ophthalmic lenses such as contact lenses, intraocular lenses, artificial cornea, and spectacle lenses. Among these, they are particularly suited for ophthalmic lenses such as contact lenses, intraocular lenses, and artificial cornea. Among these, they are particularly suited for ophthalmic lenses, especially contact lenses.

### D. Experimental

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Synthesis

### a. SYNTHESIS EXAMPLE 1

To a 1 L three-necked round-bottomed flask, methacrylic acid (241.2 g), allylglycidyl ether (80.3 g), sodium methacrylate (22.7 g), and 4-methoxyphenol (1.14 g) were added, and the mixture was stirred with a mechanical stirrer. The flask was immersed in an oil bath, and the temperature was raised to 100° C., followed by stirring under heat for 4 hours while tracing the reaction by gas chromatography (GC). After allowing the reaction mixture to cool in the air, toluene (300 mL) was added, and the mixture was then transferred to a 1 L separating funnel. The mixture was then washed 7 times with 0.5N aqueous sodium hydroxide solution (300 mL) and then 3 times with saturated saline (300 mL). The organic layer was collected and dried over anhydrous sodium sulfate overnight. Solids were removed by filtration, and the filtrate was recovered in a 1 L eggplant type flask, followed by evaporating the solvent. The resulting mixture was transferred to a 500 mL eggplant type flask, and 2,6-di-t-butyl-4-methylphenol (0.23 g) was added, followed by further concentration (yield: 226.74 g). To the resulting mixture, N-nitrosophenyl hydroxylamine aluminum (0.23 g ) was added, and the resulting mixture was distilled under reduced pressure to obtain a mixture of the compounds represented by the following Formula (F1-1) and Formula (F1-2):

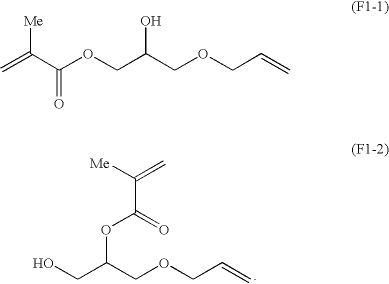

### b. SYNTHESIS EXAMPLE 2

A dropping funnel and a three-way stopcock were connected to a 200 mL three-necked round-bottomed flask. The three-way stopcock was connected to a vacuum pump and to a nitrogen line. While reducing the pressure in the apparatus with the vacuum pump, the apparatus was heated with a heat gun and then nitrogen was blown into the flask to restore the pressure to the normal pressure. This operation was repeated three times to eliminate moisture in the apparatus. Hexamethylcyclotrisiloxane (22.25 g, 0.1 mol) and toluene (25.7 mL) were added to the flask, and the mixture was stirred with a magnetic stirrer. After hexamethylcyclotrisiloxane was completely dissolved, the flask was immersed in a water bath (room temperature), and 169 mL (0.27 mol) of 1.6 mol/L butyl lithium solution in hexane was added dropwise thereto for 34 minutes, followed by stirring the resulting mixture at room temperature for 1 hour. The flask was cooled in a salt-containing ice bath, and a solution prepared by dissolving hexamethylcyclotrisiloxane (66.75 g, 0.3 mol) in anhydrous tetrahydrofuran (165 mL) was added dropwise for 60 minutes. The resulting mixture was stirred under cooling for 150 minutes, and then stirred for 45 minutes at room temperature. A solution prepared by dissolving dimethylchlorosilane (39 mL) in tetrahydrofuran (100 mL) was added dropwise for 45 minutes, and the resulting mixture was stirred for 1 hour. The resulting solution was washed 4 times with about 400 mL (a total of 1.6 L) of water, and anhydrous sodium sulfate was added to the organic layer to dry it. The mixture was filtered through a pleated filter paper to remove the solids, and the filtrate was collected in an eggplant type flask, followed by evaporation of the solvent. The resulting mixture was subjected to purification with a semi-micro rectifier (produced by SOGO LABORATORY GLASS WORKS CO., LTD, catalog No. 2004), to obtain the compound represented by the following Formula (F2) (GC purity: 99%):

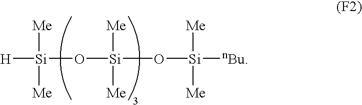

### c. SYNTHESIS EXAMPLE 3

To a 1 L three-necked flask equipped with a mechanical stirrer, stirring blade, and a Dimroth condenser, a mixture (103 g, 0.514 mol) of the compounds represented by the above-described Formula (F1-1) and Formula (F1-2), carbon carrying 5% of platinum (produced by WAKO PURE CHEMICAL INDUSTRIES, LTD.) and toluene (103 mL) were added, and the flask was immersed in an oil bath, followed by stirring the mixture. The temperature of the oil bath was raised to 60° C., and 106 g (0.257 mol) of the compound represented by the above-described Formula (F2) were added dropwise, followed by stirring the mixture for 60 minutes under heat.

After completion of the reaction, to remove the 5% platinum-carrying carbon, filter paper was laid on a Kiriyama funnel, and Celite was added to the half depth of the funnel, followed by filtration under reduced pressure. After the filtration, toluene was evaporated with a rotary vacuum evaporator (water bath temperature: 60° C.). The residual liquid after concentration was transferred to a wide-mouthed eggplant type flask, and 2,6-di-t-butyl-4-methylphenol as a polymerization inhibitor was added to the residual liquid in an amount of 2% by weight based on the residual liquid, followed by dissolving the polymerization inhibitor. A stirring bar was placed in the flask and the flask was fixed on a stand. The pressure was reduced with a vacuum pump equipped with a liquid nitrogen trap while stirring the mixture, and the eggplant type flask was immersed in an oil bath, followed by raising the temperature to 140° C. From the time point at which the temperature reached 140° C., the flask was aspirated with the vacuum pump while stirring the mixture for 1 hour to remove the excess mixture of the compounds represented by the above-described Formula (F1-1) and Formula (F1-2), to obtain a mixture of the compounds represented by Formula (F3-1) and Formula (F3-2) below. Afterwards, the resulting material was evaluated for clarity and color: haze was not observed (a rating of A).

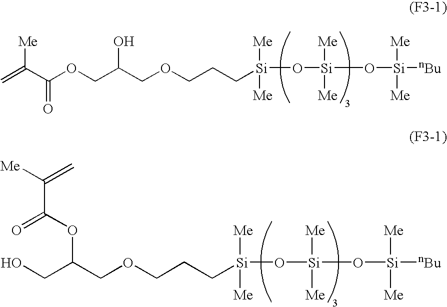

### d. SYNTHESIS EXAMPLE 4

To a 300 mL eggplant type flask, a compound (100 g, 0.3 mol) represented by the following Formula (F4),

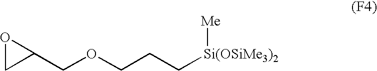

methacrylic acid (103.4 g, 1.2 mol), sodium methacrylate (4.8 g, 0.05 mol), and p-methoxyphenol (5.5 g, 0.04 mol) were added, and the mixture was heated in the air at 100° C. After confirming that the area % of the compound of the Formula (F4) decreased to not more than 0.1% by GC, the reaction solution was cooled to room temperature. Hexane (150 mL) was added to the reaction solution, and the mixture was washed 3 times with 0.5M aqueous sodium hydroxide solution (250 mL) and then 3 times with 2.6% saline (175 mL). Anhydrous sodium sulfate was added to the organic layer to dry it, and the solvent was evaporated after filtration to obtain a mixture of the compounds represented by the following Formula (F5-1) and Formula (F5-2). Afterwards, the resulting material was evaluated for clarity and color: haze was not observed (a rating of A).

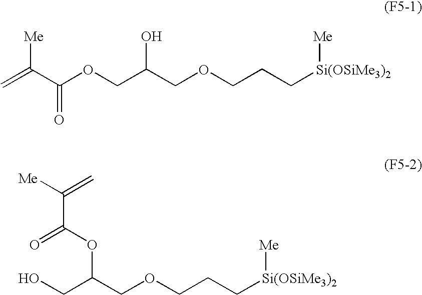

2. Purification

### a. PURIFICATION EXAMPLE 1

To the mixture (crude product) of the compounds represented by Formula (F3-1) and Formula (F3-2) obtained in the above-described Synthesis Example 1, 5% by weight of 4-methoxynaphthol was added and dissolved therein. Using a thin film distillation apparatus (short path distillation apparatus) type KDL5 manufactured by UIC GmbH, preliminary distillation of the crude product was carried out under the following Conditions 1 to separate the solution into distillate and non-distillate (residual solution). The distillate obtained in the preliminary distillation was distillated again (main distillation) under the following Conditions 2 to separate the product into distillate and non-distillate (residual solution).

i. Conditions 1

The solution was separated into distillate and non-distillate. Distillation Temperature: 120° C. Inner Condenser Temperature: 40° C. Inner Pressure: full vacuum (0.02 mbar or less, the value indicated by the vacuum meter appended to the apparatus). Wiper Speed: 350 rpm. Feed Rate: 170 g/h.

ii. Conditions 2

The material was purified in the main distillation. Distillation Temperature: 140° C. Inner Condenser Temperature: 40° C. Inner Pressure: full vacuum (0.02 mbar or less, the value indicated by the vacuum meter appended to the apparatus). Wiper Speed: 350 rpm. Feed Rate: 170 g/h.

To the distillate (100 parts by weight) of the main distillation, hexane (70 parts by weight) was added. Washing and liquid-liquid separation with 170 parts by weight of 0.5M aqueous sodium hydroxide solution was repeated three times. Then washing and liquid-liquid separation with 170 parts by weight of 10% by weight aqueous sodium chloride solution was repeated twice. After dehydration with anhydrous sodium sulfate (10 parts by weight), active carbon (5 parts by weight) was added, and the resulting mixture was stirred at room temperature for 1 hour. After filtration, the solvent was evaporated to obtain a purified mixture of the compounds represented by Formula (F3-1) and Formula (F3-2). The results are shown in Table 1.

### b. PURIFICATION EXAMPLES 2 AND 3, AND COMPARATIVE EXAMPLES 1-11

The same operations as in Example 1 were repeated, except that the compound shown in Table 1 was used as a polymerization inhibitor in place of 4-methoxynaphthol. The results are shown in Table 1.

### c. PURIFICATION EXAMPLE 4

To the mixture (crude product) of the compounds represented by Formula (F5-1) and Formula (F5-2) obtained in the above-described Synthesis Example 1, 5% by weight of 4-methoxynaphthol was added and dissolved therein. Using a thin film distillation apparatus (short path distillation apparatus) type KDL5 manufactured by UIC GmbH, preliminary distillation of the crude product was carried out under the following Conditions 1 to separate the solution into distillate and non-distillate (residual solution). The distillate obtained in the preliminary distillation was distillated again (main distillation) under the following Conditions 2 to separate the product into distillate and non-distillate (residual solution).

i. Conditions 1

The solution was separated into distillate and non-distillate. Distillation Temperature: 110° C. Inner Condenser Temperature: 40° C. Inner Pressure: full vacuum (0.02 mbar or less, the value indicated by the vacuum meter appended to the apparatus). Wiper Speed: 350 rpm. Feed Rate: 350 g/h.

ii. Conditions 2

The material was purified in the main distillation. Distillation Temperature: 130° C. Inner Condenser Temperature: 40° C. Inner Pressure: full vacuum (0.02 mbar or less, the value indicated by the vacuum meter appended to the apparatus). Wiper Speed: 350 rpm. Feed Rate: 170 g/h.

To the distillate (100 parts by weight) of the main distillation, hexane (70 parts by weight) was added. Washing and liquid-liquid separation with 170 parts by weight of 0.5M aqueous sodium hydroxide solution was repeated three times. Then washing and liquid-liquid separation with 170 parts by weight of 10% by weight aqueous sodium chloride solution was repeated twice. After dehydration over anhydrous sodium sulfate (10 parts by weight), active carbon (5 parts by weight) was added, and the resulting mixture was stirred at room temperature for 1 hour. After filtration, the solvent was evaporated to obtain a purified mixture of the compounds represented by Formula (F5-1) and Formula (F5-2). The results are shown in Table 2.

### d. PURIFICATION EXAMPLES 5 AND 6, AND COMPARATIVE EXAMPLE 12

The same operations as in Example 1 were repeated except that the compound shown in Table 2 was used as a polymerization inhibitor in place of 4-methoxynaphthol. The results are shown in Table 2.

3. Material Evaluation

The disclosed materials and the comparative materials can be evaluated and rated for clarity and color.

a. Clarity Evaluation Method

A sample of the material to be evaluated was dissolved in acetonitrile having a weight 20 times that of the sample (e.g., for a 1 g sample, about 20 g of acetonitrile can be used), and the state of the solution was visually observed. The observed state was evaluated for clarity or turbidity (i.e., clear or hazy) and given a rating in accordance with the following criteria:
A. The solution in acetonitrile was transparent.
B. The solution in acetonitrile was slightly hazed.
C. The solution in acetonitrile was weakly hazed.
D. The solution in acetonitrile was moderately hazed.
E. The solution in acetonitrile was prominently hazed.
F. Viscosity is increased or a jelly-like polymerization product was formed in the apparatus during distillation. Distillation was stopped.

The resulting ratings for the evaluated materials are tabulated in Tables 1 and 2. From the above descriptions, it is apparent that a material rated at A is more clear (i.e., less hazed) than a material rated at B, which is more clear than a material rated at C, which is more clear than a material rated at D, which is more clear than a material rated at E, which is more clear than a material rated at F.

It is also understood that further methods of evaluating clarity or turbidity can also be used. For example, it is contemplated that the disclosed materials and the comparative materials can be evaluated using well-known optical methods. It is also understood that the disclosed materials and the comparative materials can be evaluated using well-known methods for evaluation of purity, for example, chromatographic methods including gas chromatography (GC) and high-performance liquid chromatography (HPLC). Without wishing to be bound by theory, it is believed that, in general, materials that are more clear (i.e., less hazed) are more pure (e.g., have less impurities resulting from polymerization or decomposition during distillation).

b. Color Evaluation Method

A sample of the material to be evaluated was placed in a glass test tube, and the degree of coloring was visually observed.

The resulting ratings for the evaluated materials are tabulated in Tables 1 and 2. It is also understood that further methods of evaluating color can also be used. For example, it is contemplated that the disclosed materials and the comparative materials can be evaluated using well-known optical methods (e.g., ultraviolet/visible (UV/Vis) spectroscopy). Without wishing to be bound by theory, it is believed that, in general, materials that are less colored (e.g. colorless or lightly colored) are more pure (e.g., have less impurities resulting from polymerization or decomposition during distillation).

TABLE 1

| | | Test of | |
|---|---|---|---|
| | | Dissolved | |
| | | State in | |
| | | Ace- | Degree of |
| | Polymerization Inhibitor | tonitrile | Coloring |
| Example 1 | 4-methoxynaphthol | A | colorless |
| Example 2 | 2-t-butylhydroquinone | A | slightly brown |
| Example 3 | 2,5-di-t-butylhydroquinone | B | slightly brown |
| Comparative | hydroquinone | C | weak brown |
| Example 1 | | | |
| Comparative | 4-t-butylcatechol | C | weak brown |
| Example 2 | | | |
| Comparative | 4-methoxyphenol | F | slightly brown |
| Example 3 | | | |
| Comparative | 2-t-butyl-4-methoxyphenol | E | slightly brown |
| Example 4 | | | |
| Comparative | 2,6-di-t-butyl-4-methylphenol | D | slightly brown |
| Example 5 | | | |
| Comparative | DBHT | C | slightly brown |
| Example 6 | | | |
| Comparative | TTHP | C | slightly brown |
| Example 7 | | | |
| Comparative | 2,2,6,6-tetramethylpiperidine | D | considerably |
| Example 8 | N-oxyl | | strong brown |
| Comparative | 2,2-diphenyl-1-picrylhydrazyl | C | considerably |
| Example 9 | | | strong brown |
| Comparative | N-nitrosophenylhydroxyl | C | considerably |
| Example 10 | amine aluminum salt | | strong brown |
| Comparative | N-nitrosophenylhydroxyl | B | considerably |
| Example 11 | amine ammonium salt | | strong brown |

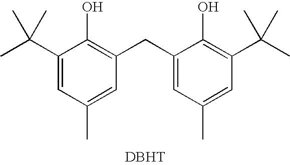

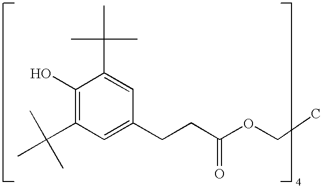

TTHP

TABLE 2

| | | Test of | |
|---|---|---|---|
| | | Dissolved | |
| | | State in | Degree of |
| | Polymerization Inhibitor | Acetonitrile | Coloring |
| Example 4 | 4-methoxynaphthol | A | colorless |
| Example 5 | 2-t-butylhydroguinone | A | slightly brown |
| Example 6 | 2,5-di-t-butylhydroguinone | B | slightly brown |
| Comparative | 4-methoxyphenol | E | slightly brown |
| Example 12 | | | |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for purifying a siloxanyl monomer, the method comprising the step of reduced pressure distillation of the siloxanyl monomer in the presence of at least one polymerization inhibitor comprising an alkylhydroquinone or a hydroxynaphthalene.

2. The method of claim 1, further comprising the step of collecting the distilled siloxanyl monomer.

3. The method of claim 1, wherein the at least one polymerization inhibitor comprises a hydroxynaphthalene.

4. The method of claim 3, wherein the hydroxynaphthalene is an alkoxy naphthol, a dihydroxynaphthol, or a dialkoxynaphthol.

5. The method of claim 3, wherein the hydroxynaphthalene is 4-methoxy-1-naphthol.

6. The method of claim 1, wherein the at least one polymerization inhibitor comprises an alkylhydroquinone comprising at least one alkyl group.

7. The method of claim 6, wherein the alkyl group comprises a substituted or unsubstituted C₁ to C₁₂ alkyl group.

8. The method of claim 6, wherein the alkyl group is a tertiary alkyl group.

9. The method of claim 6, wherein the alkylhydroquinone is 2-t-butylhydroquinone or 2,6-di-t-butylhydroquinone.

10. The method of claim 1, wherein the siloxanyl monomer comprises at least one polymerizable carbon-carbon unsaturated bond in an alkylacryloyl moiety.

11. The method of claim 1, wherein the siloxanyl monomer is represented by the following Formula (A1-1) or (A1-2): 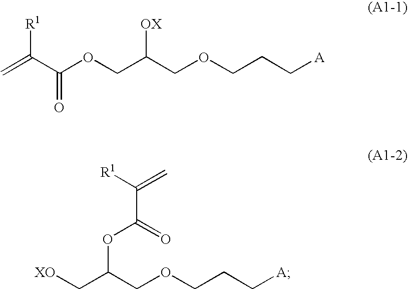
wherein R¹ represents hydrogen, substituted or unsubstituted C₁ -C₁₈ alkyl, or substituted or unsubstituted phenyl;
wherein X represents hydrogen or a hydrolyzable group; and
A represents a siloxanyl group.

12. The method of claim 11, wherein A is a group represented by the following Formula (B1): 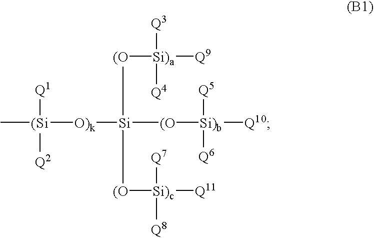
wherein Q¹ to Q¹¹ independently represent hydrogen, substituted or unsubstituted C₁-C₂₀ alkyl, or substituted or unsubstituted C₆-C₂₀ aryl;
wherein k represents an integer of 0 to 200; and
wherein a, b, and c independently represent integers of 0 to 20, with the proviso that k, a, b, and c are not simultaneously zero.

13. The method of claim 11, wherein A is a group represented by the following Formula (B2): 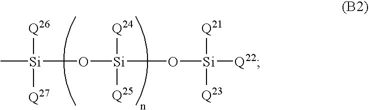
wherein Q²¹ to Q²⁷ independently represent hydrogen, substituted or unsubstituted C₁-C₁₈ alkyl, or substituted or unsubstituted phenyl; and
wherein n represents an integer of 0 to 12.

14. The method of claim 1, wherein the distillation is thin film distillation.

15. The method of claim 1, wherein the distillation is carried out at a temperature of at least 110° C.

16. The method of claim 1, further comprising the step of removing at least a portion of the at least one polymerization inhibitor.

17. The method of claim 16, wherein the step of removing at least a portion of the at least one polymerization inhibitor is performed by washing of the reaction mixture with an alkaline aqueous solution and treatment with active carbon.

18. A compound purified by the method of claim 1.

19. A polymer comprising at least one residue of a compound of claim 18.

20. A molded article, ophthalmic lens, or contact lens comprising the polymer of claim 19.
